(19) United States
(12) Patent Application Publication
(10) Pub. No.: US 2005/0015419 A1
(43) Pub. Date: Jan. 20, 2005

(54) Techniques to provide programmable finite impulse response filtering

(76) Inventors: Chiang Pu, Chandler, AZ (US); Scott Chiu, Folsom, CA (US); Yonghui Tang, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/619,771

(22) Filed: Jul. 14, 2003

(51) Int. Cl. G06F 17/10

(52) U.S. Cl. 708/306

(57) ABSTRACT

Briefly, a finite impulse response filter to generating coefficients having a programmable magnitude and quantum tunability.

### FIELD

The subject matter disclosed herein generally relates to techniques to filter signals.

### DESCRIPTION OF RELATED ART

Digital domain signal processing is common. Digital signals need to be converted to analog signal format for real world use. Digital-to-analog converters (DAC) convert digital signals to analog format. DACs utilize low-pass filtering before a digital signal is converted to analog format. A finite impulse response (FIR) filter is one efficient approach to implement low-pass filtering. An N-tap FIR filter with coefficients a(k) and input x(n) can have an output y(n) can described by:
y(n)=a(0)x(n)+a(1)x(n−1)+a(2)x(n−2)+ . . . a(N−1)x(n−N+1),
For example, analog coefficients (a(0) . . . a(N−1)) can be implemented by providing currents having magnitudes proportional to the coefficient value.

### BRIEF DESCRIPTION OF THE DRAWINGS

The subject matter regarded as the invention is particularly pointed out and distinctly claimed in the concluding portion of the specification. The invention, however, both as to organization and method of operation, may best be understood by reference to the following detailed description when read with the accompanying drawings in which:

FIG. 1 depicts a filter, in accordance with an embodiment of the present invention;

FIG. 2 depicts an example of a current mirror set, in accordance with an embodiment of the present invention; and

FIG. 3 depicts a system in which some embodiments of the present invention may be used, in accordance with an embodiment of the present invention.

Note that use of the same reference numbers in different figures indicates the same or like elements.

### DETAILED DESCRIPTION

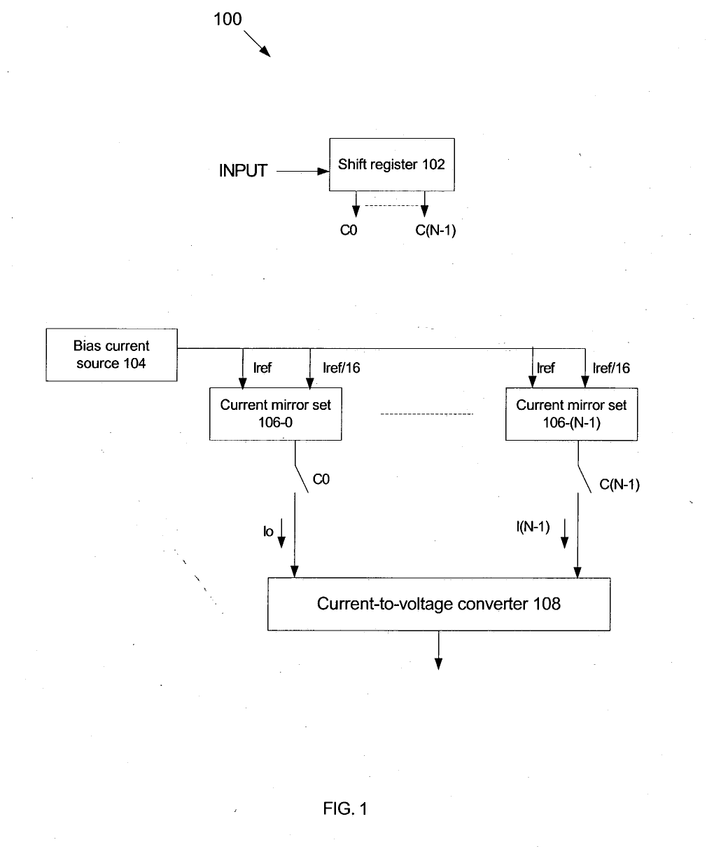

In accordance with an embodiment of the present invention, FIG. 1 depicts a filter 100. One implementation of filter 100 may include a shift register 102, bias current source 104, current mirror sets 106-0 to 106-(N−1), and current-to-voltage converter 108. Herein, current mirror set 106 refers to any or all of current mirror sets 106-0 to 106-(N−1).

Filter 100 may receive a digital input signal labeled INPUT and provide an analog voltage representation of such digital input signal. For example, filter 100 may be used as an N-tap FIR filter having programmable coefficients, a(i), where i=0 to N−1, as in the relationship described earlier. The magnitude and quantum tunability of each coefficient, a(i), may be independently programmed. Magnitudes of coefficients, a(i), may be based on a filter program (e.g., a rectangular window, hamming window, or hanning window).

Shift register 102 may receive digital input signal INPUT. Shift register 102 may output multiple bits, C₀ . . . C_{N-1}. The output of shift register 102 may be initialized to zero. At each increment of a clock signal, shift register 102 may step bits of signal INPUT among output bits. The output bits of shift register 102, C₀ . . . C_{N-1}, may control which of current mirror sets 106-0 to 106-(N−1) provide current to current-to-voltage converter 108. In one implementation, each output bit, Cᵢ, may control whether an associated current conducting switch that couples a current mirror set 106-i to current-to-voltage converter 108 allows current to flow from such current mirror set 106-i to current-to-voltage converter 108. The current provided by all of the current mirror sets 106-0 to 106-(N−1) at any time, t, may be represented in time by the following relationship:
Iₛᵤₘ(t)=I₀*(C₀(t))+I₁*(C₁(t))+ . . . I_{N-1}*(C_{N-1}(t))
where
   I₀ to I_{N-1} are currents provided by respective current mirror sets 106-0 to 106-(N−1), and
   C₀(t) to C_{N-1}(t) are the one/zero levels of output bits from the shift register 102 as a function of time t.

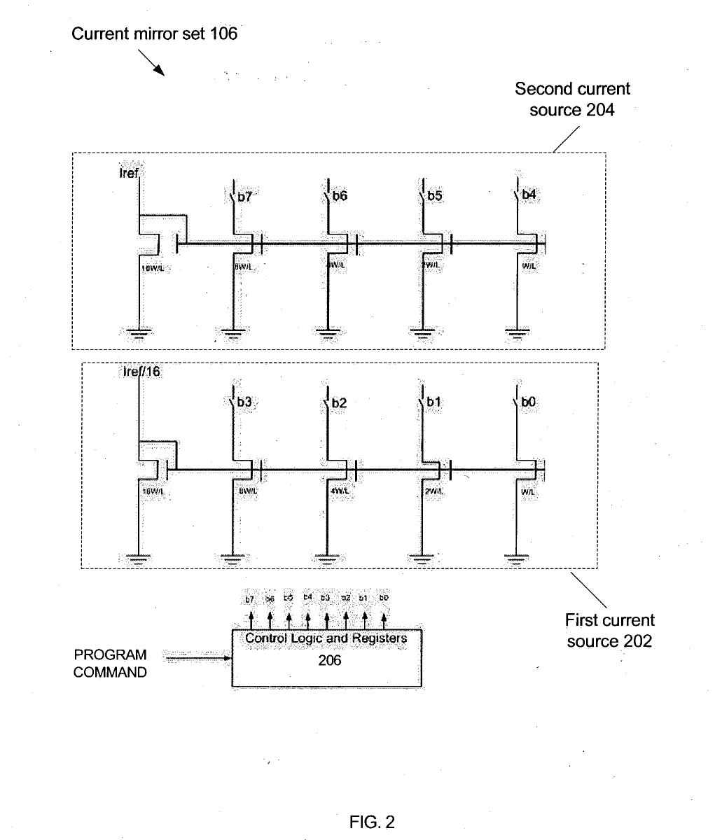

FIG. 2 depicts an example of a current mirror set 106-i, in accordance with an embodiment of the present invention. One implementation of current mirror set 106-i may include first current source 202, second current source 204, and control logic and register block 206. Bias current source 104 may provide currents I_{ref}/16 and I_{ref} to respective first current source 202 and second current source 204.

Each current mirror set 106-i may provide current Iᵢ that represents a coefficient, a(i). The amount of current, Iᵢ, output by each current mirror set 106-i can be independently programmed to be any level and any incremental tunability.

Control logic and register block 206 may decode a command (labeled “PROGRAM COMMAND”) and provide an “m” bit control signal to control the level of current output by each current mirror set 106-i. In the implementation of FIG. 2; the command is 3-bits and “m” is 8-bits. Other numbers of control bits may be used to control the increments by which the level of current from each current mirror set 106-i can be varied.

In one implementation, each current mirror set 106-i may include an integer “m” switches (b₀ . . . bₘ₋₁) that control whether an individual current source within current mirror set 106-i provides current contribution output from the current mirror set 106-i. In one implementation, first current source 202 may provide a current that is approximately equal to:
1/16*[b₀/16+b₁/8+b₂/4+b₃/2]*I_{ref},
where each of b₀, b₁, b₂, and b₃ are either ‘0’ or ‘1’.
   Second current source 204 may provide a current that is approximately equal to:
   [b₄/6+b₅/8+b₆/4+b₇/2]*I_{ref},
where each of b₄, b₅, b₆, and b₇ are either ‘0’ or ‘1’.
   The amount of current (Iᵢ) output by each current mirror set 106-i can be represented by the following equation:
   Iᵢ={1/16*[b₀/16+b₁/8+b₂/4+b₃/2]+[b₄/16+b₅/8+b₆/4+b₇/2]}*I_{ref}
where
   b₀ . . . b₇ are an 8-bit input to each current mirror set 106-i
   and bⱼ=0 if the switch is open or 1 if the switch is closed (where j=0 to 7).

Currents from current mirror sets 106-0 to 106-(N−1) may be summed and the sum converted to a voltage to provide an FIR filter response to an input signal. The output voltage, Vout, may be represented by:
Vout=Isum*R
where R is an impedance (e.g., resistor) value in current-to-voltage conversion.

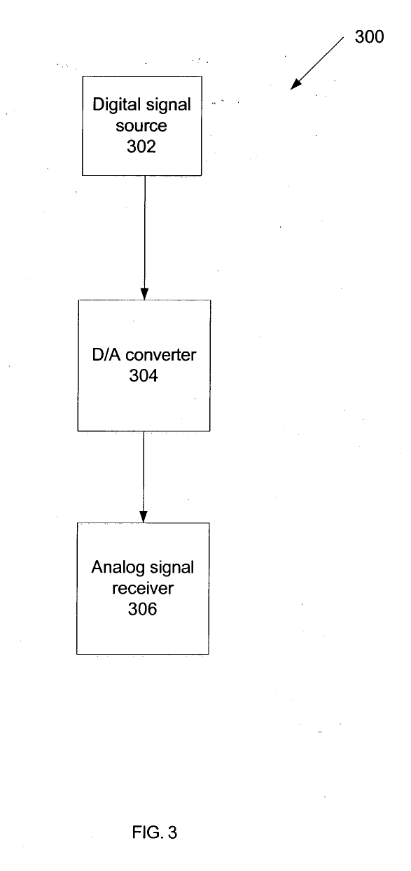

FIG. 3 depicts a system 300 in which some embodiments of the present invention may be used. System 300 may include a digital signal source 302, digital-to-analog (“D/A”) converter 304, and analog signal receiver 306. System 300 may be used for example in a transmitter device in a communications system. Digital signal source 302 may provide a digital signal to D/A converter 304. Examples of digital signal source 302 include but are not limited to an audio signal source, a video signal source, or communications signal source.

D/A converter 304 may utilize some embodiments of the present invention to convert digital signals to analog format. D/A converter 304 may provide an analog version of the digital signal from digital signal source 302 to analog signal receiver 306. Analog signal receiver 306 may filter, amplify analog signals, and/or provide sufficient power to drive analog devices (such as speaker or a transmission medium).

Modifications

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. An apparatus comprising:
at least two current sources, wherein the amount of current provided by each of the at least two current sources is based on at least one multi-bit control signal and wherein each of the at least two current sources selectively provides current in response to at least one coefficient on-state command; and
a summer to sum currents of each of the at least two current sources.

2. The apparatus of claim 1, further comprising a shift register to provide at least one coefficient on-state command in response to an input signal.

3. The apparatus of claim 1, further comprising a bias current source to provide bias current to each of the at least two current sources.

4. The apparatus of claim 1, further comprising a current-to-voltage converter to convert current from the summer into a voltage.

5. The apparatus of claim 1, wherein each current represents a coefficient in a finite impulse response input-output relationship.

6. The apparatus of claim 1, wherein a sum of currents represents an output in a finite impulse response input-output relationship.

7. A method comprising:
selectively providing at least two currents in response to at least one coefficient on-state command, wherein the amount of each of the two currents is based on at least one multi-bit control signal; and
summing each of the at least two currents.

8. The method of claim 7, further comprising selectively providing the at least one coefficient on-state command in response to an input signal.

9. The method of claim 7, further comprising converting the sum of currents into a voltage.

10. The method of claim 7, wherein each current represents a coefficient in a finite impulse response input-output relationship.

11. The method of claim 7, wherein a sum of currents represents an output in a finite impulse response input-output relationship.

12. A system comprising:
a digital signal source;
at least two current sources, wherein the amount of current provided by each of the at least two current sources is based on at least one multi-bit control signal and wherein each of the at least two current sources selectively provides current in response to at least one coefficient on-state command;
a summer to sum currents of each of the at least two current sources;
a shift register to provide at least one coefficient on-state command in response to the digital signal source; and
an analog signal receiver to receive the current sum.

13. The system of claim 12, wherein the digital signal source comprises an audio signal source.

14. The system of claim 12, wherein the digital signal source comprises a video signal source.

15. The system of claim 12, wherein the digital signal source comprises a communications signal source.

16. The system of claim 12, wherein the analog signal receiver comprises an amplifier.

17. The system of claim 12, wherein the analog signal receiver comprises a line driver.
